(19) United States
(12) Patent Application Publication
(10) Pub. No.: US 2015/0161057 A1
(43) Pub. Date: Jun. 11, 2015

(54) SYSTEM AND METHOD FOR PROVIDING CLIENT-SIDE ADDRESS TRANSLATION IN A MEMORY MANAGEMENT SYSTEM

(71) Applicant: Qualcomm Incorporated, San Diego, CA (US)

(72) Inventors: THOMAS M. ZENG, SAN DIEGO, CA (US); AZZEDINE TOUZNI, SAN DIEGO, CA (US); STEPHEN A. MOLLOY, CARLSBAD, CA (US); SATYAKI MUKHERJEE, BANGALORE (IN); ABHIRAMI SENTHILKUMARAN, SAN DIEGO, CA (US); OLAV HAUGAN, SAN DIEGO, CA (US); TZUNG REN TZENG, SANTA CLARA, CA (US); TAREK ZGHAL, SAN DIEGO, CA (US); JEAN-LOUIS O. TARDIEUX, SAN DIEGO, CA (US); AJAY UPADHYAYA, BANGALORE (IN); ZHURANG ZHAO, SAN DIEGO, CA (US); PAWAN CHHABRA, BANGALORE (IN); SUBRAHMANYAM MOOLA, SAN DIEGO, CA (US); PAVAN KUMAR, BANGALORE (IN); JAYDEEP R. CHOKSHI, SAN DIEGO, CA (US); VICTOR K. WONG, SAN DIEGO, CA (US); VIPUL C. GANDHI, SAN DIEGO, CA (US)

(73) Assignee: Qualcomm Incorporated, San Diego, CA (US)

(21) Appl. No.: 14/147,555

(22) Filed: Jan. 5, 2014

(30) Foreign Application Priority Data
Dec. 5, 2013 (IN) 5603/CHE/2013

(51) Int. Cl. G06F 12/10

(52) U.S. Cl. CPC G06F 12/1027

(57) ABSTRACT

Systems and methods are disclosed for providing memory address translation for a memory management system. One embodiment of such a system comprises a memory device and an application processor in communication via a system interconnect. The application processor comprises test code for testing one or more of a plurality of hardware devices. Each of the hardware devices has a corresponding system memory management unit (SMMU) for processing memory requests associated with the hardware device to the memory device. The system further comprises a client-side address translation system in communication with the system interconnect and the plurality of SMMUs. The client-side address translation system is configured to selectively route stimulus traffic associated with the test code to a client port on one or more of the plurality of SMMUs for testing the corresponding hardware devices.

### RELATED APPLICATION STATEMENT

This application claims priority under 35 U.S.C. 119(b) to Indian Patent Application Serial No. 5603/CHE/2013, entitled, “SYSTEM AND METHOD FOR PROVIDING CLIENT-SIDE ADDRESS TRANSLATION IN A MEMORY MANAGEMENT SYSTEM,” filed on Dec. 5, 2013 (Qualcomm Ref. No. 134615IN). The entire contents of this application are hereby incorporated by reference.

### DESCRIPTION OF THE RELATED ART

Memory management units (MMUs) are critical components for system-on-chip (SoC) functionality and performance for hardware in portable computing devices, such as mobile phones. Providing on-chip debug capability for system interprocessors (IPs) significantly increases software team productivity and decreases the bring-up time. Conventional SoCs with debug capabilities include a system memory management unit (SMMU) that uses a standard address translation system, such as, for example, those described in the Address Translation Services (ATS) 1.1 Specification provided by PCI-SIG, including any earlier or future versions (collectively referred to as “the ATS Specification”), which is hereby incorporated by reference in its entirety. With distributed memory management unit architectures becoming the preferred implementation of choice, hardware challenges make it difficult to support such debugging features.

Accordingly, there is a need in the art for improved architectures that enable chip debug and/or profiling functionality for distributed memory management unit systems.

### SUMMARY OF THE DISCLOSURE

Systems and methods are disclosed for providing memory address translation for a memory management system. One embodiment of such a system comprises a memory device and an application processor in communication via a system interconnect. The application processor comprises test code for testing one or more of a plurality of hardware devices. Each of the hardware devices has a corresponding system memory management unit (SMMU) for processing memory requests associated with the hardware device to the memory device. The system further comprises a client-side address translation system in communication with the system interconnect and the plurality of SMMUs. The client-side address translation system is configured to selectively route stimulus traffic associated with the test code to a client port on one or more of the plurality of SMMUs for testing the corresponding hardware devices.

Another embodiment is a method for providing client-side address translation in a memory management system. One such method comprises: an application processor initiating test code for testing one or more of a plurality of hardware devices, each hardware device having a corresponding system memory management unit (SMMU) for processing associated memory requests to a memory; selecting one or more of the hardware devices to be tested using the test code; and injecting stimulus traffic associated with the test code to a client port on the respective one or more SMMUs corresponding to the selected one or more hardware devices to be tested.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for providing client-side address translation in a memory management system.

FIG. 2 is a block diagram illustrating an embodiment of a system for implementing the client-side address translation system (CATS) in the system of FIG. 1.

FIG. 3 is a flow chart illustrating an embodiment of a method implemented in the system of FIG. 1 for providing client-side address translation in a memory management system.

FIG. 4 is a block diagram illustrating another embodiment of system for implementing the CATS in the system of FIG. 1.

FIG. 5 is a block diagram of an embodiment of a portable computer device comprising the system of FIG. 1.

### DETAILED DESCRIPTION

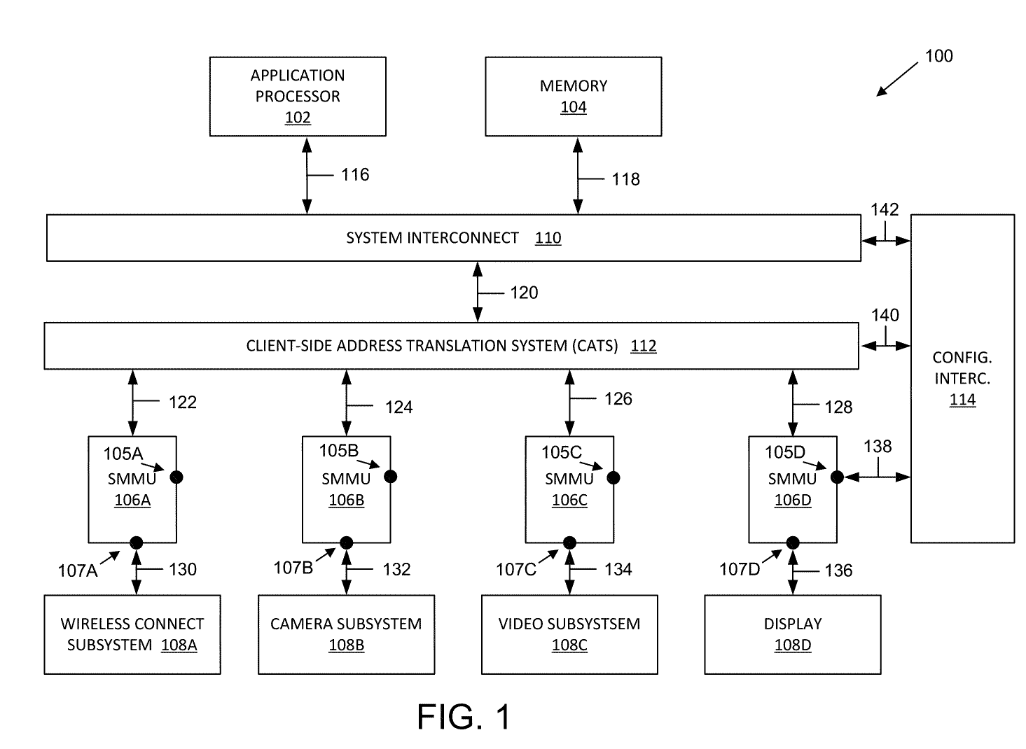

FIG. 1 illustrates an embodiment of a system 100 for providing client-side address translation in a memory management system. It should be appreciated that the system 100 may be incorporated in any desirable computing device or system. In an embodiment, the system 100 resides in a portable computing device comprising a mobile telephone, a smartphone, a navigation device, or a hand-held computer with a wireless connection or link. In general, the system 100 provides address translation operations for selectively testing (e.g., debugging and/or profiling) and bringing up one or more of a plurality of system memory management units (SMMUs) 106a, 106b, 106c, and 106d without having to bring up the upstream master hardware (i.e., client hardware devices 108a, 108b, 108c, and 108, respectively) of the SMMU.

As illustrated in FIG. 1, the system 100 comprises an application processor 102, a memory system 104, and a client-side address translation system (CATS) 112 interconnected via a system interconnect 110. As described below, in an embodiment, one or more of the components in system 100 may be included on a system on chip (SoC), which may include other components, such as, multiple general purpose processors. The memory system 104 may comprise one or more double data rate (DDR) memory devices, although other types of general or specific purpose memory may be implemented. For example, in an embodiment, it may be useful to separate debugging of the SMMUs 106 from DDR memory.

The system interconnect 110 may comprise one or more components, including, for example, a bus integrated memory controller and a system network on chip. The application processor 102 may comprise a central processing unit, which includes a test program for debugging and/or profiling hardware devices 108a, 108b, 108c, and 108d via memory address translation operations provided via CATS 112.

It should be appreciated that any processor in the system 100 may comprise the application processor 102 and be used to inject the stimulus traffic. A single source or multiple sources of data may be injected to the SMMUs 106a, 106b, 106c, and 106d by one or more of the processors incorporated in the system 100. In this manner, CATS 112 enables data translation from a virtual address space to a physical address space associated with memory 104. CATS 112 provides the infrastructure for enabling data injection to the SMMUs 106 and a means for validating that the data translated is the same data used for reference, which is known by the CPU. It should be appreciated that the validation may be performed in CATS 112, SMMUs 106, and/or in memory 104 for long consecutive blocks of data to track low probability error events.

In operation of system 100, the test program in application processor 102 may issue memory read and/or write requests to memory locations, use the SMMU traffic path to translate the virtual address of the read or write requests, and then check whether the data returned (or written) to memory 104 matches the expected data. As described below in more detail, CATS 112 provides a mechanism to implement these features in a way that tests the actual end-to-end path of the address translation. It should be appreciated that CATS 112 provides an SMMU address translation stimulus matrix that traverse the same data path as the client ports 107a, 107b, 107c, and 107d in SMMUs 106a, 106b, 106c, and 106d, respectively, which is referred to as client-side address translation. In contrast to conventional SMMU implementations that require configuration-side address translation operations, client-side address translation may provide a more effective or reliable means for simulating test scenarios. Furthermore, CATS 112 may provide a means for generating arbitrary traffic patterns, not just single beat read/write as used in conventional configuration-side implementations.

It should be further appreciated that system 100 may provide various debug, profiling, and/or testing features. For example, CATS 112 may verify SMMU functionality during bring-up. In existing configuration-side implementations, verification is completed using conventional address translation operation services, such as described in the ATS Specification identified above. CATS 112 may also generate traffic patterns based on test pattern data files on the application processor 102 to test the performance of the SMMUs 106a, 106b, 106c, and 106d.

CATS 112 may be incorporated in various types of SMMU architectures. For example, CATS 112 may be implemented in SMMU architectures that support direct virtual-to-physical address translation or two-stage memory address translation involving a first stage for translating a virtual address to an intermediate physical address (IPA) and a second stage for translating the IPA to a physical address in memory 104. Two-stage address translation may be implemented in systems that use hypervisors in the CPU, including, for example, server-type devices and high-end portable computing devices, such as, smart phones.

As further illustrated in FIG. 1, the application processor 102 communicates with system interconnect 110 via interface 116. Memory 104 communicates with system interconnect 110 via interface 118. CATS 112 communicates with system interconnect 110 via interface 120. The system 100 may further comprise a configuration interconnect 114 for providing conventional configuration-side functionality. The configuration interconnect 114 may communicate with system interconnect 110 via interface 142, CATS 112 via interface 140, and the SMMUs 106 via interface(s) 138. SMMUs 106a, 106b, 106c, and 106d may comprise client ports 107a, 107b, 107c, and 107d, respectively, and configuration ports 105a, 105b, 105c, and 105d, respectively.

Each SMMU 106a, 106b, 106c, and 106d may manage memory resources for a separate hardware device. In the embodiment illustrated in FIG. 1, SMMU 106a manages memory resources for a wireless connect subsystem 108a via interface 130 in communication with client port 107a. SMMU 106b manages memory resources for a camera subsystem 108b via interface 132 in communication with client port 107b. SMMU 106c manages memory resources for a video subsystem 108c via interface 134 in communication with client port 107c. SMMU 106d manages memory resources for a mobile display 108d via interface 136 in communication with client port 107d.

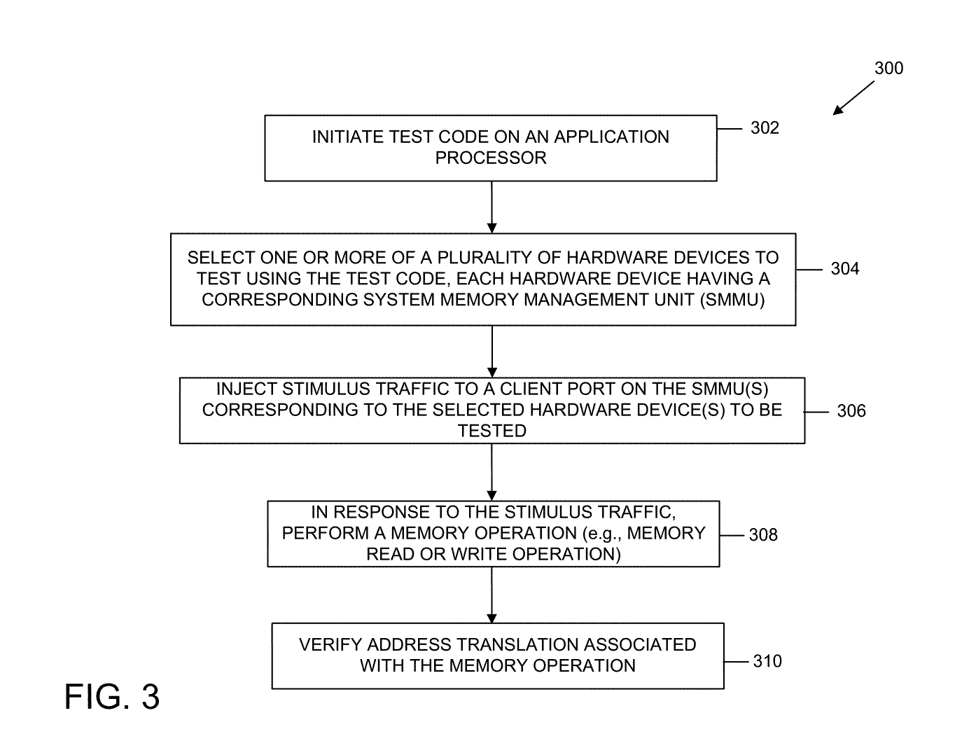

FIG. 3 is a flow chart illustrating an embodiment of a method 300 for providing client-side address translation in the system 100. At block 302, in a test mode, the application processor 102 initiates the test program. The test mode may be configured in any suitable manner. It should be appreciated that, in an embodiment, each context bank in a SMMU 106 may be selectively enabled. In this manner, one of the context banks in an SMMU 106 may be used in the test mode while other context banks in the same SMMU may be simultaneously used in mission mode. This may enable system 100 to test complex concurrency scenarios, which provides an effective tool to test performance of the system platform. Complex concurrency testing scenarios may be advantageous to, for example, properly size hardware devices for hardware cost optimization in certain types of test platforms, including field-programmable gate array (FPGA)-type test platforms.

The test program may provide stimulus traffic to system interconnect 112. The stimulus traffic may comprise memory read and/or write requests to a memory location in a predetermined physical address range. CATS 112 receives the stimulus traffic via interface 120 and, at block 304, selects the hardware devices 108 to be tested. For example, CATS 112 may select mobile display 108d and/or the associated SMMU 106d. At block 306, CATS 112 injects the stimulus traffic to the traffic path associated SMMU 108d to translate the virtual address of the read or write requests associated with display 108d. It should be appreciated that the stimulus traffic may be injected to the SMMUs in various ways. For example, in one embodiment, memory mapping techniques may be used in the bus infrastructure to reroute the data differently during testing operation and runtime operation. At block 308, in response to the stimulus traffic, the associated memory operation(s) (e.g., read and/or write operations) may be performed by the memory 104. At block 310, the system 100 may verify address translation associated with the memory operation(s) by, for example, checking whether data returned or written to memory 104 matches the expected data.

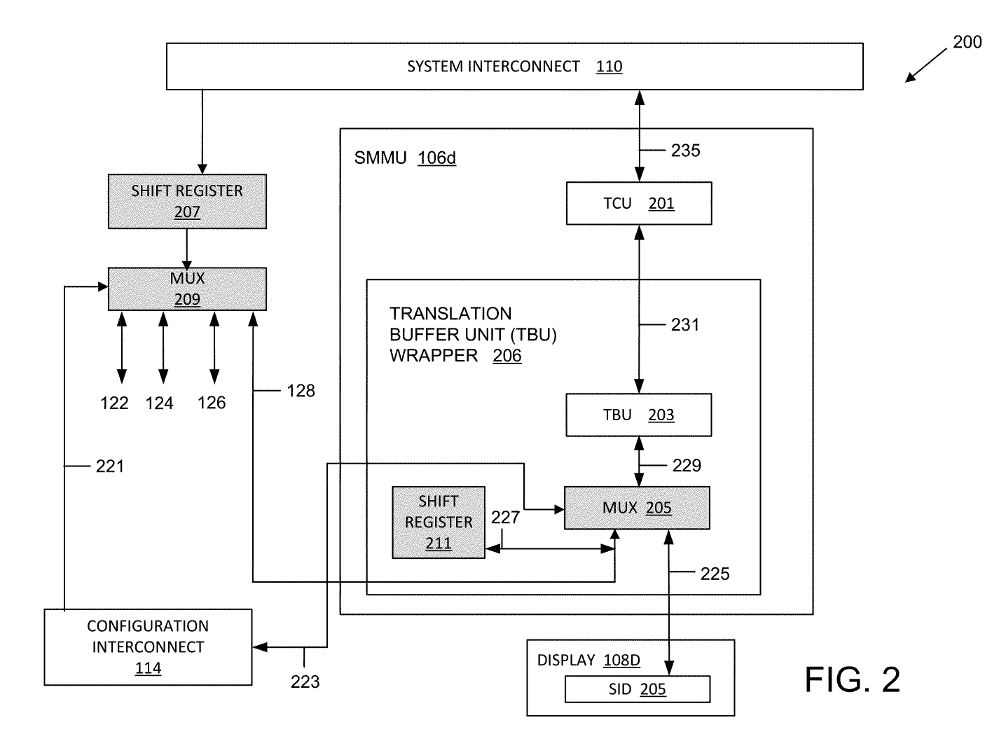

FIG. 2 illustrates an embodiment of a system 200 for implementing CATS 112. CATS 112 may comprise a shift register 207, a multiplexer 209, and a shift register 211 and a multiplexer 205 forming part of a translation buffer unit (TBU) wrapper 206 in the respective SMMUs 106a, 106b, 106c, and 106d. FIG. 2 only illustrates a single SMMU 106d with a TBU wrapper 206 comprising the shift register 211 and the multiplexer 205. It should be appreciated, however, that SMMU 106a, 106b, and 106c have similarly configured TBU wrappers 206 that communicate with the multiplexer 209 and configuration interconnect 114.

As illustrated in FIG. 2, shift register 207 receives receiving the stimulus traffic from the application processor via system interconnect 112. The output of shift register 207 may be provided to multiplexer 209, which is configured to select one or more of the TBU wrappers 206 to target based on a selection signal provided by the configuration interconnect 114 on a connection 221. In this regard, the multiplexer 209 may comprise an output 213 for the TBU wrapper (not shown) associated with SMMU 106a, an output 215 for the TBU wrapper (not shown) associated with SMMU 106b, an output 217 for the TBU wrapper (not shown) associated with SMMU 106c, and an output 219 for the TBU wrapper 206 associated with SMMU 106d.

In this manner, CATS 112 may selectively inject the test traffic from application processor 105 to the selected TBU wrapper. FIG. 2 shows the multiplexer 209 injecting the test traffic to TBU wrapper 206 associated with SMMU 106d and display 108d. It should be appreciated that the injected test traffic can either replace or augment mission mode traffic. The stimulus traffic may be routed from the test code running on the application processor 105 to the SMMU client port 107d using a dedicated or existing address range.

It should be appreciated that CATS 112 may form a logic matrix-topology for software to select which TBU wrapper to target, and whether to allow concurrency of test traffic with the mission mode traffic. The injection of a read or write transaction with a bit pattern, followed by verifying that the translation is correct based on the fact that the pattern gets read from or written to the memory cell of the correct physical address. CATS 112 facilitates the injection of software-initiated test traffic to the TBU wrapper 206.

As illustrated in the embodiment of FIG. 2, the SMMU 106d comprises the TCU 201 and the TBU wrapper 206. TBU wrapper 206 houses the translation buffer unit (TBU) 203, which may comprise a Translation Look-Aside Buffer (TLB). One of ordinary skill in the art will appreciate that the TCU 201 may interact with one or more TBUs 203 to perform the associated page table walk.

The two multiplexers 209 and 205 form a cross bar between the system interconnect 110 (via the shift register 207) and the plurality of SMMUs 106, which functions as the client-side address translation stimulus matrix. CATS traffic is sourced from system interconnect 110 based on an address range reserved for CATS 112 in the system interconnect 110. CATS traffic goes from the application processor 105 to one or more TBU wrappers 206 under test, as selected by the mux 209.

At the selected TBU wrapper 206, CATS traffic either replaces or augments traffic from the TBU master hardware or client. Augmenting refers to injecting both types of traffic into the TBU wrapper 206, provided the input address ranges do not overlap. This may enable greater flexibility in debug and profiling. In an embodiment, the total address range may be determined according to:

nTBU×mCB×rCB; where:
CB=context bank;
nTBU=the number of TBUs that can be active simultaneously for CATS
mCB=the maximum CB per TBU
rCB=the aperture in Megabytes (MB) per CB
bits for mCB in address range can be used as SID

It should be appreciated that CATS 112 may provide various additional benefits over configuration-side address translation used in ARM-based architectures. The client-side address translation provided by CATS 112 is not limited to stage 1 context banks CATS 112 may also test stage 2 context configurations. CATS traffic may use a direct address in system interconnect 112 to derive the input address to the TBU wrapper 206.

As further illustrated in FIG. 2, the TBU wrapper 206 may comprise a shift register 211 for injecting the CATS traffic anywhere in an input address map. The final input address=offset+CATS address. The shift register 211 may be used to test bypass where output address equals input address. As illustrated in FIG. 2, the register 211 may generate applicable stream identifiers (SID 205) for bit patterns used for the testing of the applicable hardware.

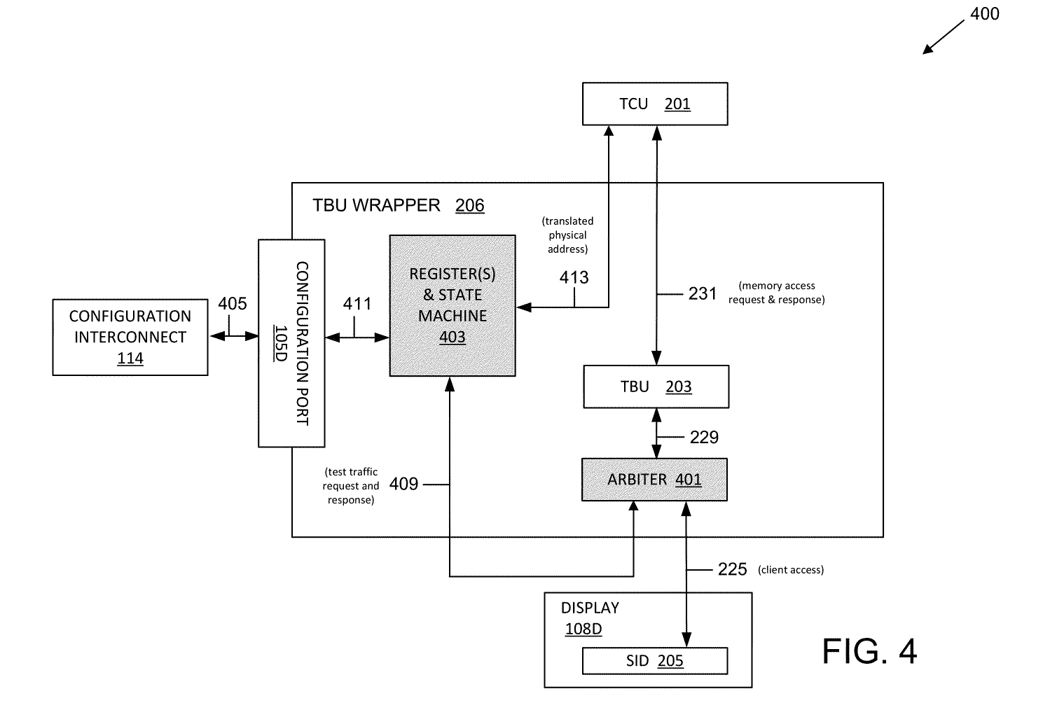

FIG. 4 illustrates an alternative embodiment of a system 400 for implementing CATS 112 via a TBU wrapper 206. Each TBU wrapper 206 associated with the SMMUs 106a, 106b, 106c, and 106d may comprise registers and state machine 403. As illustrated in the embodiment of FIG. 4 for SMMU 106d, the register(s) and state machine 403 may communicate with the SMMU configuration port 105d via an interface 411, which receives data from the configuration interconnect 114 via an interface 405. The register(s) and state machine 403 may be programmed with, for example, the one or more of the following information: the memory operation to be performed (e.g., a read or write); the virtual address for the operation; and any write data in the case of a write operation). It should be appreciated that the translation output could be captured in the register(s) and state machine 403 from the memory 104 or stored in the memory 104. The register(s) and state machine 403 may comprise a subset of the configuration register space in a memory address map, which is set aside for access to the registers via the configuration port 105d of the TBU wrapper 206.

As further illustrated in FIG. 4, the configuration port 105d may be presented as an input to the TBU wrapper 206 via the interface 405. The register(s) and state machine 403 may communicate with the TCU 201 via an interface 413. The TBU wrapper 206 may further comprise an arbiter 401. The arbiter 401 communicates with the register(s) and state machine via an interface 409. The arbiter 401 communicates with the TLB 203 via interface 229. Client access to the TBU wrapper 206 by the display 108d is provided via interface 225. The translated physical address (interface 413) and/or the return data from the memory operations (interface 231) may be stored in the register(s) and state machine 403 or another register that is also accessible via the configuration register space. In this regard, system 400 may enable testing of the request path from the client (e.g., display 108d) to the TBU, testing of the page-table walk path from the TCU 201 to memory 104, and/or testing of the actual memory operation to memory 104. System 400 enables the entire virtual address space to be available for test traffic injection into each TBU.

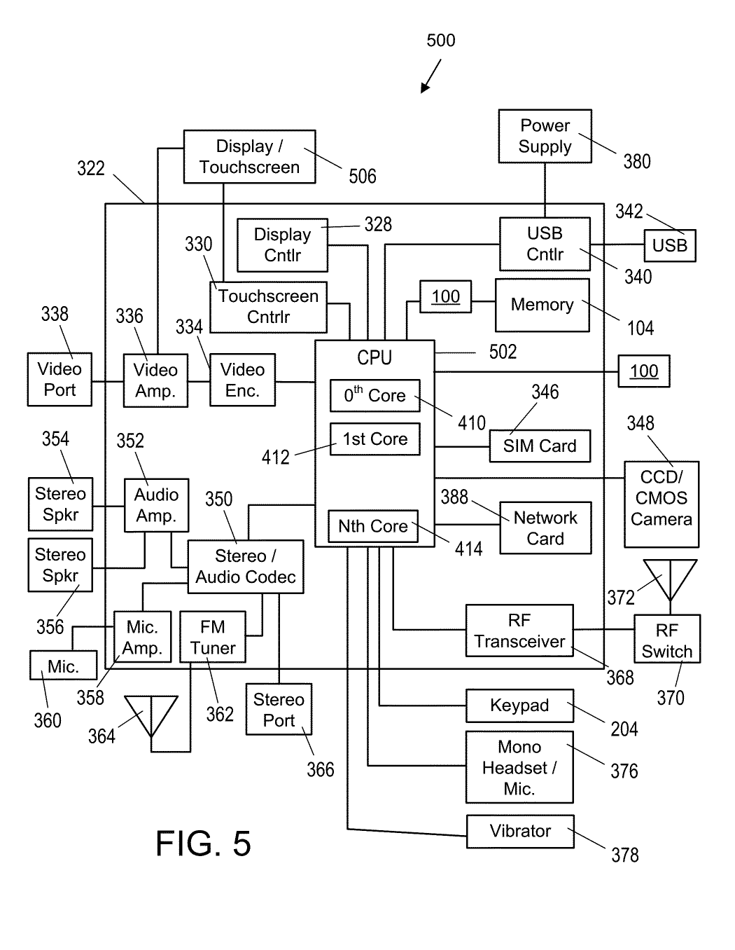

As mentioned above, the system 100 may be incorporated into any desirable computing system. FIG. 5 illustrates the system 100 incorporated in an exemplary portable computing device (PCD) 500. It will be readily appreciated that certain components of the system 100 are included on the SoC 322 (FIG. 5) while other components (e.g., the memory 104) are external components coupled to the SoC 322. The SoC 322 may include a multicore CPU 402A. The multicore CPU 502 may include a zeroth core 410, a first core 412, and an Nth core 414. One of the cores may comprise, for example, a graphics processing unit (GPU) with one or more of the others comprising the CPU. The GPU may be part of the CPU or separate. It should be further appreciated that other CPU cores (e.g., for modem, video, audio, etc.) may be distributed in the SoC 322.

A display controller 328 and a touch screen controller 330 may be coupled to the CPU 502. In turn, the touch screen display 506 external to the on-chip system 322 may be coupled to the display controller 328 and the touch screen controller 330.

FIG. 5 further shows that a video encoder 334, e.g., a phase alternating line (PAL) encoder, a sequential color a memoire (SECAM) encoder, or a national television system(s) committee (NTSC) encoder, is coupled to the multicore CPU 502. Further, a video amplifier 336 is coupled to the video encoder 334 and the touch screen display 506. Also, a video port 338 is coupled to the video amplifier 336. As shown in FIG. 5, a universal serial bus (USB) controller 340 is coupled to the multicore CPU 502. Also, a USB port 342 is coupled to the USB controller 340. Memory 104 and a subscriber identity module (SIM) card 346 may also be coupled to the multicore CPU 1202. Memory 104 may reside on the SoC 322 or be coupled to the SoC 322.

Further, as shown in FIG. 5, a digital camera 348 may be coupled to the multicore CPU 502. In an exemplary aspect, the digital camera 348 is a charge-coupled device (CCD) camera or a complementary metal-oxide semiconductor (CMOS) camera.

As further illustrated in FIG. 5, a stereo audio coder-decoder (CODEC) 350 may be coupled to the multicore CPU 502. Moreover, an audio amplifier 352 may coupled to the stereo audio CODEC 350. In an exemplary aspect, a first stereo speaker 354 and a second stereo speaker 356 are coupled to the audio amplifier 352. FIG. 5 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 5 further illustrates that a radio frequency (RF) transceiver 368 may be coupled to the multicore CPU 402A. An RF switch 370 may be coupled to the RF transceiver 368 and an RF antenna 372. As shown in FIG. 5, a keypad 204 may be coupled to the multicore CPU 502. Also, a mono headset with a microphone 376 may be coupled to the multicore CPU 502. Further, a vibrator device 378 may be coupled to the multicore CPU 502.

FIG. 5 also shows that a power supply 380 may be coupled to the on-chip system 322. In a particular aspect, the power supply 380 is a direct current (DC) power supply that provides power to the various components of the PCD 500 that require power. Further, in a particular aspect, the power supply is a rechargeable DC battery or a DC power supply that is derived from an alternating current (AC) to DC transformer that is connected to an AC power source.

FIG. 5 further indicates that the PCD 500 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, a television/cable/satellite tuner, or any other network card well known in the art. Further, the network card 388 may be incorporated into a chip, i.e., the network card 388 may be a full solution in a chip, and may not be a separate network card 388.

As depicted in FIG. 5, the touch screen display 506, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 322.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for providing client-side address translation in a memory management system, the method comprising:
an application processor initiating test code for testing one or more of a plurality of hardware devices, each hardware device having a corresponding system memory management unit (SMMU) for processing associated memory requests to a memory;
selecting one or more of the hardware devices to be tested using the test code; and
injecting stimulus traffic associated with the test code to a client port on the respective one or more SMMUs corresponding to the selected one or more hardware devices to be tested.

2. The method of claim 1, further comprising:
in response to the stimulus traffic, the memory performing a memory operation associated with the stimulus traffic.

3. The method of claim 2, wherein the memory operation comprises one of a memory read or a memory write.

4. The method of claim 2, further comprising:
verifying an address translation associated with the memory operation.

5. The method of claim 4, wherein verifying the address translation comprises:
capturing translation output; and
comparing the translation output to a reference output known by a central processing unit.

6. The method of claim 5, wherein the translation output is captured in one of a register in the corresponding SMMU and the memory.

7. The method of claim 1, wherein the memory device comprises a double data rate (DDR) memory device.

8. The method of claim 1, wherein injecting the stimulus traffic comprises:
selecting a translation buffer unit (TBU) associated with the corresponding SMMU.

9. A system for providing memory address translation for a memory management system, the system comprising:
a memory device and an application processor in communication via a system interconnect, the application processor comprising test code for testing one or more of a plurality of hardware devices;
each of the hardware devices having a corresponding system memory management unit (SMMU) for processing memory requests associated with the hardware device to the memory device;
a client-side address translation system in communication with the system interconnect and the plurality of SMMUs, the client-side address translation system configured to selectively route stimulus traffic associated with the test code to a client port on one or more of the plurality of SMMUs for testing the corresponding hardware devices.

10. The system of claim 9, wherein the SMMUs comprise a translation buffer unit (TBU) and a translation control unit (TCU) for translating a virtual address space to a physical address space.

11. The system of claim 9, wherein the client-side address translation system comprises a pair of multiplexers forming a cross bar between the system interconnect and one or more of the plurality of SMMUs.

12. The system of claim 9, wherein the SMMUs comprise a register for capturing translation output from the memory device.

13. The system of claim 9, wherein the memory device comprises a double data rate (DDR) memory device.

14. The system of claim 9, wherein the client-side address translation system comprises a multiplexer for receiving the stimulus traffic from the application processor via the system interconnect and selectively injecting the stimulus traffic to one or more of the SMMUs.

15. A system for providing client-side address translation in a memory management system, the system comprising:
means for initiating test code for testing one or more of a plurality of hardware devices, each hardware device having a corresponding system memory management unit (SMMU) for processing associated memory requests to a memory;
means for selecting one or more of the hardware devices to be tested using the test code; and
means for injecting stimulus traffic associated with the test code to a client port on the respective one or more SMMUs corresponding to the selected one or more hardware devices to be tested.

16. The system of claim 15, further comprising:
means for performing a memory operation associated with the stimulus traffic in response to the stimulus traffic.

17. The system of claim 16, wherein the memory operation comprises one of a memory read or a memory write.

18. The system of claim 16, further comprising:
means for verifying an address translation associated with the memory operation.

19. The system of claim 18, wherein the means for verifying the address translation comprises:
means for capturing translation output; and
means for comparing the translation output to a reference output known by a central processing unit.

20. The system of claim 19, wherein the translation output is captured in one of a register in the corresponding SMMU and the memory.

21. The system of claim 15, wherein the memory comprises a double data rate (DDR) memory device.

22. The system of claim 15, wherein the means for injecting the stimulus traffic comprises:
means for selecting a translation buffer unit (TBU) associated with the corresponding SMMU.

23. A computer program embodied in a computer-readable medium and executable by a processing device, the computer program for providing client-side address translation in a memory management system, the computer program comprising logic configured to:
initiate test code for testing one or more of a plurality of hardware devices, each hardware device having a corresponding system memory management unit (SMMU) for processing associated memory requests to a memory;
select one or more of the hardware devices to be tested using the test code; and
inject stimulus traffic associated with the test code to a client port on the respective one or more SMMUs corresponding to the selected one or more hardware devices to be tested.

24. The computer program of claim 23, further comprising:
logic configured to perform a memory operation associated with the stimulus traffic in response to the stimulus traffic.

25. The computer program of 24, wherein the memory operation comprises one of a memory read or a memory write.

26. The computer program of claim 24, further comprising:
logic configured to verify an address translation associated with the memory operation.

27. The computer program of claim 26, wherein the logic configured to verify the address translation comprises logic configured to:
capture translation output; and
compare the translation output to a reference output known by a central processing unit.

28. The computer program of claim 27, wherein the translation output is captured in one of a register in the corresponding SMMU and the memory.

29. The computer program of claim 23, wherein the memory comprises a double data rate (DDR) memory device.

30. The computer program of claim 23, wherein the logic configured to inject the stimulus traffic comprises:
logic configured to select a translation buffer unit (TBU) associated with the corresponding SMMU.
